(19) United States
(12) Patent Application Publication
(10) Pub. No.: US 2006/0045954 A1
(43) Pub. Date: Mar. 2, 2006

(54) Vanilla flavoring compositions

(76) Inventors: Douglas Young, Budd Lake, NJ (US); Klaus Bauer, Little Silver, NJ (US); Matthias Guentert, Ridgewood, NJ (US); Teresa Augurusa, Wayne, NJ (US); Sherry Genchi, Clifton, NJ (US)

Correspondence Address: PENDORF & CUTLIFF, 5111 MEMORIAL HIGHWAY, TAMPA, FL, 33634-7356, US

(21) Appl. No.: 11/185,494

(22) Filed: Jul. 20, 2005

Related U.S. Application Data
(60) Provisional application No. 60/606,366, filed on Sep. 1, 2004.

(51) Int. Cl. A23L 1/22

(52) U.S. Cl. 426/534

(57) ABSTRACT

The addition of Maillard based flavorings to volatile vanilla flavor compositions was found to significantly improve a flavorings' taste profile and increase long-lasting in-product performance (especially in dairy and baked goods). The novel flavoring composition more closely mimics the properties (taste and performance) of highly prized natural vanilla extracts.

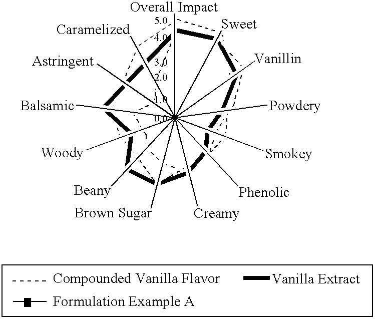

### FIELD OF THE INVENTION

Imitation vanilla flavors often lack the full-bodied, long lasting roundness and depth of a true vanilla extract, especially in dairy products and baked goods such as cookies. The present invention provides a process for improving the taste profile of an imitation vanilla flavor, making it more closely resemble real vanilla extract in taste and performance, and further concerns vanilla flavor compositions produced according to the process.

### BACKGROUND OF THE INVENTION

Natural vanilla extracts are arguably among the most highly prized flavorings in the world, so much so, that to prevent adulteration, they are the only flavorings to be standardized by the FDA (CFR Title 21 Paragraph 169.175 to 177 and others). Vanilla extracts are used in food preparations such as beverages, desserts, dairy products, ice cream, confections, tobacco, baked goods such as cakes, cereals cookies and others. In CFR 21, Paragraph 169.175, vanilla extract is described as the alcohol extractive of cured vanilla beans, the fruit from the orchid Vanilla planiflora or Vanilla tahitensis. A single fold is standardized as 13.35 oz of vanilla bean per gallon of liquid—comprising 35% alcohol (minimum), and/or glycerin, sugar and water. Vanilla extracts can be made to different strengths (called folds). Vanilla beans are grown and commercially available from Madagascar, Mexico, Tahiti, Indonesia and Tonga. As with many natural products, the flavor, quality and particularly the price of vanilla can vary great depending upon the growing conditions such as regional soil conditions, climate and plantation practices. The flavor of vanilla extracts reflect this natural variability. Even with this natural flavor variability all vanilla extracts owe their flavor to the characterizing chemical, vanillin, found in the vanilla bean. A number of artificial flavor chemicals (not found occurring in nature) such as ethyl vanillin and propenyl guaethol are also known to be characteristic of vanilla.

As a derivative of a natural product, vanilla extracts' price and supply is subject to the whimsy of climatic, economic, social, and political forces. Vanillin and/or ethyl vanillin, alone or with other volatile chemicals (nature identical or artificial) are often used by the flavor industry to extend and/or replace costly natural vanilla extracts. These blended chemical vanillin compositions (commonly known to the art of flavor creation as “compounded flavors”) can be reasonably characterizing of vanilla. As is known to the art of flavor creation, chemicals can be added to provide sweet, creamy, smoky, woody, floral and fermented notes. Imitation vanillas are commonly made from vanillin and/or ethyl vanillin dissolved in ethyl alcohol and other volatile flavor chemicals known to the art. Such imitation flavors can also contain non-flavoring ingredients such as propylene glycol, glycerin, sugar, invert sugar and caramel color.

However, the general public is still able to distinguish a product created with a compounded imitation flavor from a product prepared with a natural flavor. There is thus a need for a process by which the taste profile of an artificial vanilla can be improved. The process should be simple and reproducible to avoid batch-to-batch variation when carried out on an industrial scale. Finally, the improved flavor composition should have in-product performance similar to natural vanilla, including thermal stability (particularly in baking conditions) and should impart a long-lasting taste impression.

Attempts have been made to improve the endurance of taste impression of natural vanilla flavored products. For example, JP 03004767-A2 discloses vanilla flavored milk preparations with a long-lasting vanilla flavor. These preparations are manufactured by heating vanilla bean materials with (i) milk materials, (ii) monosaccharides, and/or disaccharides, and (iii) proline, aspartic acid, glutamic acid, and/or their salts under such conditions that reactions occur between amino and oxo groups. Sucrose-containing milk, concentrated milk, sucrose, glucose-fructose liquid sugar, vanilla bean extract, tragacanth gum, sodium aspartate, proline, sodium glutamate, valine, and DL-alanine were mixed at approximately 95° C. for 1 h to manufacture vanilla-milk flavor with high potency. However, since natural vanilla is used as the starting material, the reference has no relevancy to the present invention, which is concerned with enhancing the taste profile of imitation vanilla.

JP 58005159-A discloses a durable vanilla flavor imparting agent. Vanilla flavor is obtained by heat-treating vanilla beans or vanilla extract in presence of at least one compound which takes part in sugar-amino acid reaction selected from sugar components and amino acids, at a temperature at which sugar-amino acid reaction is induced. As amino acid proline, oxyproline, arginine, lysine and their salts can be used and as sugar component 2-4C alpha-dicarbonyl compounds, 2-4C alpha,beta-hydroxy-carbonyl compounds and sugars can be used. Preferably the amino acid is used at 0.01-50 (especially 0.1-10) weight % on vanilla beans, sugar component and amino acid are used in a weight ratio of 0.01:1-100:1, especially 0.05:1-20:1. Crushed vanilla beans are mixed with the hydrochloride of arginine and/or lysine, and one or more saccharides such as glyoxal, glycerinaldehyde, maltose, glucose, etc., heated together with a solvent such as water, ethanol, propylene glycol, etc. at 40-150° C. for 5 min-48 hr, and the extract is separated. As an alternative method, extracted vanilla extract is mixed with an amino acid and a carbonyl compound, and the mixture is heat treated to obtain the vanilla flavuor. The method yields a vanilla flavor which has a strong durable flavor-imparting action. It can be used for imparting vanilla flavor to ice cream cakes, chocolate, biscuit, cakes, cocoa, liquor, etc. However, since natural vanilla is again used as the starting material, the reference has no relevancy to the present invention, which is concerned with enhancing the taste profile of imitation vanilla.

### SUMMARY OF THE INVENTION

The present invention is concerned with a process for improving the taste profile of imitation vanilla flavor compositions, which often lack the full-bodied, long lasting roundness and depth of a true vanilla extract. Imitation vanilla flavor does not match the in-product performance of a true vanilla extract, especially in dairy products and baked goods such as cookies. The object of the invention is to provide a process for improving imitation vanilla flavor such that it more closely resembles real vanilla extract in taste and performance.

The invention further concerns the imitation vanilla flavor produced by the inventive process, and exhibiting improved properties, in particular, stability under baking conditions and endurance of taste impression.

This invention accomplishes these objects through
(a) producing Maillard reaction based flavors, and
(b) adding these Maillard reaction based flavors to an imitation vanilla flavor.

A Maillard reaction flavor (as is known to the art of flavor creation) is commonly created by the reaction of a nitrogen bearing compound(s) with a carbonyl bearing compound(s). The nitrogen source is typically an amino acid and/or protein, and the carbonyl source is typically a reducing sugar and/or complex carbohydrate. The combination of the reactants are typically heated which then causes a myriad of reactions common to cooking to occur, including browning and caramellization.

### DETAILED DESCRIPTION OF THE INVENTION

Applicants have found that the product of the reaction, preferably under a pressure of 1-4 bar, of rather commonly used reaction partners such as amino acids (preferably alanine, leucine and phenylalanine, but also including, preferably only up to 5% of the total amino acids, of one or more of arginine, aspartic acid, glutamic acid, glutamine, glycine, histidine, hydroxyproline, isoleucine, lysine, proline, serine, threonine, tyrosine, and valine) and simple sugars or complex carbohydrates (specifically dextrose, sucrose, fructose and polysaccharides, with up to 5% of the total reducing sugar or carbonyl containing complex carbohydrate optionally comprised of one or more of ribose, arabinose, xylose, and maltose; an exhaustive discussion of complex carbohydrates can be found in Kirk-Othmer Encyclopedia of Chemical Technology, Fourth Edition, Vol. 4, John Wiley and Sons, NY pp. 930-948, 1995, which is herein incorporated by reference), when added to an imitation vanilla flavor, can favorably add organoleptically to the imitation vanilla flavor by supplementing the imitation vanilla flavor with the compounds similar to those which make a natural, complex vanilla extract taste different than the pure chemical, vanillin. While the present invention is not bound to any textbook explanation of the chemistry of Maillard reactions, it is generally said that they involve the reaction of aldehydes and ketones (most notably reducing sugars) with alpha-amino nitrogen (typically from free amino acids and small peptides) during heating (complex reactions between the amino acids of proteins and the keto groups of sugars).

Further it was found that inclusion of vanillin and/or vanilla related flavor chemicals to the first step of the Maillard process further improved the reaction products' fidelity and performance after addition to the imitation vanilla. In fact, by creating such a complete imitation vanilla flavor, the organoleptic difference to commercially available natural vanilla extract is very much minimized. Even more surprising was that the detectable difference between natural vanilla extract and the inventive enhanced imitation vanilla in food applications (such as baked cookies) was also minimized. These Maillard based flavors, like true vanilla extract, gave mouth-feel to dairy products and stability to baked goods.

As is known to the art, the flavor profile and performance of a Maillard reaction is dependent upon the reaction partners [amino acid(s), carbohydrate(s), solvent(s) and miscellaneous chemicals] chosen, their total amounts, their relative proportion, and the processing conditions of time, temperature, pressure, active water and pH. Given the number of variables for processing conditions and ingredient combinations, the possible experimental permutations is enormous. By creating the Maillard reaction products separately from the imitation vanilla flavor, the synthesis process can be simplified and variables better controlled. An example of a well crafted flavor providing the profile and performance suitable for this invention is provided below as:
a) The amino acids and their salts (either alone or in combination) suitable for this process are L-alanine, L-leucine, L-phenylalanine
b) The carbohydrates (either alone or in combination) suitable for this process are dextrose, fructose, maltodextrins and sugar (sucrose).
c) The solvents (either alone or in combination) suitable for this process are ethyl alcohol, propylene glycol and most preferentially water and glycerin.
d) The miscellaneous vanilla related flavor chemicals (either alone or in combination) suitable for this process are most preferentially: vanillin (FEMA 3107), ethyl vanillin FEMA 2464), ethyl vanillin isobutyrate (FEMA 3837), propenyl guaethol (2922), and veratraldehyde (FEMA 3109)

In addition

Other flavor chemicals useful for this process are:

Anisaldehyde (FEMA 2670)
Anisyl acetate (FEMA 2098)
Anisyl alcohol (FEMA 2099)
Anisyl formate (FEMA 2101)
Anisyl propionate (FEMA 2102)
Dimethoxybenzene (FEMA 3799)
Ethoxymethyl phenol (FEMA 3485)
Ethyl vanillin glucopyranoside (3801)
Ethyl vanillin PG acetal (FEMA 3838)
Guaiacol (FEMA 2532)
Guaiacyl acetate (FEMA 3687)
Isoeugenyl ethyl acetate (FEMA 2472)
Isoeugenyl phenyl acetate (FEMA 2477)
Methoxymethyl phenol (FEMA 2671)
Methoxyphenyl pentenone (FEMA 2673)
Methyl butyl phenyl acetate (FEMA 2690)
Methyl sorbate (FEMA 3714)
Methyl cinnamonaldehyde (FEMA 3640)
Methyl coumarin (2699)
Phenylpropionic acid (2889)
Heliotropine (FEMA 2911)
Vanillin acetate (FEMA 3108)
Vanillin isobutyrate (FEMA 3754)
Vanillin pg acetal (FEMA 3905)
Vanillyl alcohol (FEMA 3737)
Vanillyl butyl ether (FEMA 3796)
Vanillyl ethyl ether (FEMA 3815)
Vanillylidene acetone (FEMA 3738)
Zingerone (FEMA 3124)

The processing conditions suitable for this flavor composition (% by weight):

| | |
|---|---|
| Amino acid(s) % | 5% to 40% |
| Carbohydrate(s) % | 5% to 50% |
| Solvent (s)% | 10% to 90% |
| Miscellaneous vanilla chemical(s)% | 0% to 4% |
| Reaction time range | 10 minutes to 5 hours |
| Reaction temperature range | 70° C. to 140° C. |
| Reaction pH range | 3.5 to 8.0 |
| Pressure (open vessel, reflux or pressure vessel) | Atmospheric to 100 psi |

With the preferred conditions as:

| | |
|---|---|
| Amino acid(s) % | 5% to 30% |
| Carbohydrate(s) % | 20% to 50% |
| Solvent (s)% | 20% to 50% |
| Miscellaneous vanilla chemical(s)% | 0% to 2% |
| Reaction time range | 10 minutes to 1 hours |
| Reaction temperature range | 90° C. to 121° C. |
| Reaction pH range | 4.0 to 7.0 |
| Pressure (open vessel, reflux or pressure vessel) | Atmospheric to 50 psi |

### EXAMPLES OF PREFERRED REACTION FLAVOR EMBODIMENTS

Reaction Flavor 1

| Ingredient | Weight % |
|---|---|
| L-alanine | 18.00 |
| dextrose | 40.00 |
| glycerin | 5.00 |
| water | 37.00 |

Process conditions: React at 1000° C. for 30 minutes under pressure (varied during the process, but not in excess of 4 bar) with good mixing.

Reaction Flavor 2

| Ingredient | Weight % |
|---|---|
| L-alanine | 17.50 |
| L-leucine | 0.25 |
| L-phenylalanine | 0.25 |
| dextrose | 40.00 |
| glycerin | 5.00 |
| maltodextrin | 3.50 |
| water | 33.50 |

Process conditions: Reflux at 105-1100° C. for 30 minutes with good mixing

Reaction Flavor 3

| Ingredient | Weight % |
|---|---|
| L-alanine | 18.00 |
| dextrose | 40.00 |
| vanillin | 0.70 |
| glycerin | 5.00 |
| maltodextrin | 3.50 |
| glycerin | 5.00 |
| water | 33.15 |

Process conditions: React at 1050° C. for 30 minutes under pressure (varied during the process, but not in excess of 4 bar) with good mixing.

### FINAL VANILLA FLAVOR FORMULATION EXAMPLES

In Example 1, volatile vanilla flavor related compounds (vanillin and furaneol) were combined with the Maillard Reaction Flavor 1 (the invention) as well as other non-flavoring ingredients commonly found in a vanilla extract.

### Example 1

| Ingredient | Weight % |
|---|---|
| Maillard Reaction Flavor 1 | 45.00 |
| Vanillin (FEMA 3107) | 0.25 |
| Furaneol 10% in pg (FEMA 3174) | 0.40 |
| Ethyl alcohol | 4.35 |
| Sugar | 10.00 |
| Glycerin | 5.00 |
| Water | 35.00 |

Next, Examples 2 and 3 were prepared, having the same composition as Example 1, except that Maillard Reaction Flavors 2 and 3 were substituted, respectively, for Maillard Reaction Flavor 1. As can be seen, when used in conjunction with an imitation vanilla flavor (vanillin and furaneol), the sensory characteristics of Examples 1, 2 and 3 simulated the well-rounded darker vanilla notes found in a vanilla extract. All examples improved the depth, mouth feel, roundness and in-product stability of the imitation vanilla flavor. Example 1 shows a basic brown, rounding out flavor, while Example 2 also increases the sweet caramellic notes. The reaction flavor particularly enhanced the vanilla flavor strength and character when vanillin took part in the Maillard reaction, as shown in Example 3. The choice of starting materials and the condition of the reaction varies with the type of vanilla extract profile one is trying to match.

Sensory Evaluation

Using the composition of Example 1, sensory comparison to a natural vanilla extract was conducted.

OVERALL OBJECTIVES: To determine similarities and differences between Vanilla Extract and Formulation Example 1. Two different test methods were utilized.

Triangle Difference Test:

Objective: to determine if there is an organoleptic significant difference between Formulation Example 1 and Vanilla Extract when used at the same use level in cookies

Vanilla Wafer Recipe

| Ingredient | Wt % |
|---|---|
| powdered sugar | 11.64 |
| sugar | 15.58 |
| shortening | 12.77 |
| whole egg | 12.49 |
| vanilla extract 2 fold (or replacement) | 0.43 |
| salt | 0.24 |
| cake flour | 42.79 |
| baking powder | 1.14 |
| water | 2.92 |
| Total: | 100.00 |

Bake at 325° F. for 19-20 minutes

QDA Flavor Profiling:

Objective: To determine the flavor profiles of Formulation Example 1 as compared to Compounded Vanilla Flavor and Vanilla Extract.

Methodology #1: Triangle Test

A triangle test for similarity methodology was used. This is used when no difference is expected; there is no measure of the size of the difference.

DESIGN:

| PLAN: 1 | Triangle test |
|---|---|
| Samples | 2 |
| Presented | 3 |
| Blocks | 6 |
| Factor | 10 |
| Total n | 59 |

| OPTIONS: Blinding codes | Random |
|---|---|
| Sample randomization | Yes |
| Block randomization | Yes |

Procedure:

Samples were prepared according to specifications. A standard vanilla cookie recipe was followed and cookies were prepared using equal amounts of the vanilla variant. Samples were blind coded with three digit random numbers and presented in balanced, random order. The panelists were served product in one ounce, clear plastic tasting cups. They were asked to rinse between samples. The panels were conducted in odor free sensory test booths. Data was collected and analyzed on Compusense5 sensory computer system.

Product Identification:
SAMPLE #1: Cookies made with Vanilla Extract
SAMPLE #2: Cookies made with Formulation Example 1

PANEL:

Experienced, discriminating level; N=59

RESULTS:

18 out of 59 judges correctly identified the odd (inventive) sample (30%)

Conclusion:

Given that the judges had a 50% chance of picking either cookie sample, these results showed no significant difference between these two vanilla cookie samples @ the 95% confidence level, beta=0.05, Pd=0.30.

The results clearly prove that a significant number of discriminating subjects cannot perceive a difference between cookies made with Vanilla Extract and cookies made with Formulation Example 1.

Methodology #2: quantitative descriptive analysis:
Trained panel—7
Calibrate on an intensity scale 1-7, 7=extremely high
Develop vocabulary—lexicon
Standardize and define terminology—common language
Review references
Replicate (2)
Reproducible results
Apply statistical analysis
Qualitative and quantitative data
Graphic representation of sensory profile

Samples Evaluated

(a) An Imitation Vanilla Flavor (same as Example 1 but without the Maillard Reaction Flavor of the invention).

| Ingredient | Weight % |
|---|---|
| Vanillin (FEMA 3107) | 0.25 |
| Furaneol 10% in pg (FEMA 3174) | 0.40 |
| Ethyl alcohol | 4.35 |
| Sugar | 10.00 |
| glycerin | 5.00 |
| water | 80 |

(b) Vanilla Extract
(c) Formulation Example A

Conclusions:
The Imitation Vanilla Flavor is sweet, high in vanillin, powdery, smoky, and creamy.
The profiles of Vanilla Extract and Formulation Example 1 contain those same attributes but are more closely rated in intensity.
In addition to the attributes in the Imitation Vanilla Flavor, Vanilla Extract and Formulation Example 1 contain brown sugar, beany (vanilla bean), woody, balsamic, astringent and caramelized notes that are not apparent in Imitation Vanilla Flavor.
Formulation Example 1 is closer in profile to Vanilla Extract than to Imitation Vanilla Flavor.

The results clearly show that the profile of Vanilla Extract and Formulation Example A are very similar and are clearly different from the profile of the Imitation Vanilla Favor.

The difference between Formulation Example A and Imitation Vanilla Flavor, and the similarity between Formulation Example A and Vanilla Extract, increased over time.

Results:

| | Compounded | Vanilla | Formulation |
|---|---|---|---|
| | Vanilla Flavor | Extract | Example A |
| Overall Impact | 4.4 | 4.4 | 4.9 |
| Sweet | 4.5 | 4.5 | 4.9 |
| Vanillin | 4.3 | 3.8 | 3.5 |
| Powdery | 2.9 | 2.4 | 2.6 |
| Smoky | 2.3 | 1.9 | 2.7 |
| Phendic | 2.6 | 2.4 | 2.6 |
| Creamy | 2.8 | 3.0 | 2.7 |
| Brown Sugar | 2.5 | 3.6 | 3.6 |
| Beany | 2.1 | 3.6 | 2.8 |
| Woody | 1.6 | 2.4 | 2.9 |
| Balsamic | 2.1 | 3.6 | 3.2 |
| Astringent | 1.3 | 2.9 | 3.0 |
| Caramelized | 2.0 | 3.0 | 4.1 |

What is claimed is:

1. A process for enhancing the organoleptic properties of an imitation vanilla flavor containing composition, said process comprising:
(a) producing Maillard reaction based flavor composition, and
(b) adding, to said imitation vanilla flavor containing composition, an amount of the product of step (a) sufficient to modify the organoleptic properties of said imitation vanilla flavor.

2. The process as in claim 1, wherein said Maillard reaction based flavor composition imparts to said imitation vanilla flavor brown sugar, beany (vanilla bean), woody, balsamic, astringent and caramelized notes that are not apparent in imitation vanilla flavor.

3. The process as in claim 1, wherein said Maillard reaction based flavor composition is prepared by reacting one or more nitrogen bearing compounds and one or more carbonyl bearing compounds, preferably at a temperature of between 90-121° C. and under a pressure of 1-4 bar.

4. The process as in claim 3, wherein said nitrogen bearing compound is selected from the group consisting of amino acids and proteins, and the carbonyl bearing compounds are selected from the group consisting of reducing sugars and complex carbohydrates.

5. The process as in claim 3, wherein said Maillard reaction based flavor composition is prepared by reacting one or more nitrogen bearing compounds and one or more carbonyl bearing compounds in the presence of a natural vanilla extract prior to adding the reaction product to the flavor composition comprising imitation vanilla flavor.

6. The process as in claim 3, wherein said reaction is carried out in the presence of flavor chemicals (natural or artificial) characteristic of vanilla.

7. The process as in claim 3, wherein said Maillard reaction is carried out at a temperature of between 90-121° C.

8. The process as in claim 7, wherein said Maillard reaction is carried out at 1-4 bar.

9. A flavor composition consisting of the Maillard reaction product of (a) at least one amino acid selected from the group consisting of alanine, leucine and phenylalanine and (b) a reducing sugar or carbonyl containing complex carbohydrate.

10. The composition as in claim 9, wherein said amino acid is L-alanine, L-leucine or L-phenylalanine, and wherein up to 5% of the total amino acids may be comprised of one or more of arginine, aspartic acid, glutamine, glycine, histidine, proline, threonine and valine.

11. The flavor composition as in claim 9, wherein said reducing sugar or carbonyl containing complex carbohydrate is selected from the group consisting of dextrose, fructose, maltodextrin and sucrose, and wherein up to 5% of the total reducing sugar or carbonyl containing complex carbohydrate may be comprised of one or more of ribose, arabinose, xylose, and maltose.

12. The flavor composition as in claim 9, wherein said Maillard reaction is carried out at a temperature of from 90-121° C.

13. The flavor composition as in claim 9, wherein said Maillard reaction is carried out at a pressure of from atmospheric pressure to 100 psi.

14. The flavor composition as in claim 9, wherein said Maillard reaction is carried out in the presence of a solvent selected from the group consisting of ethyl alcohol, propylene glycol, water, glycerin and mixtures thereof.

15. The flavor composition as in claim 9, wherein said Maillard reaction is carried out in the presence of one or more of vanillin (FEMA 3107), ethyl vanillin FEMA 2464), ethyl vanillin isobutyrate (FEMA 3837), propenyl guaethol (2922), and veratraldehyde (FEMA 3109).

16. A flavor composition prepared by reacting
(a) at least one amino acid selected from the group consisting of L-alanine, L-leucine or L-phenylalanine and
(b) a reducing sugar or carbonyl containing complex carbohydrate selected from the group consisting of dextrose, fructose, maltodextrin and glucose.
at a temperature of from 70° C. to 140° C., preferably 90-121° C.,
under a pressure of from Atmospheric to 100 psi, preferably Atmospheric to 50 psi,
in the presence of a solvent selected from the group consisting of ethyl alcohol, propylene glycol, water, glycerin and mixtures thereof,
for 10 minutes to 5 hours, preferably 10 minutes to 1 hour,
at pH 3.5 to 8.0, preferably pH 4.0 to 7.0.

17. The flavor composition as in claim 16, wherein said reactants comprise
5% to 40%, preferably 5% to 30% amino acid(s)
5% to 50%, preferably 20% to 50% carbohydrate(s),
0% to 4%, preferably 0% to 2%, miscellaneous vanilla flavor chemicals, and
wherein said reaction takes place in the presence of 10% to 90%, preferably 20% to 50%, solvents.

18. The flavor composition as in claim 17, wherein said Maillard reaction based flavor composition is characterized by brown sugar, beany (vanilla bean), woody, balsamic, astringent and caramelized notes that are not apparent in imitation vanilla flavor.

19. A consumable product flavored by
(a) preparing a Maillard reaction product,
(b) combining the product of step (a) with an imitation vanilla flavor composition, and
(c) adding the product of step (b) to a consumable.

20. The consumable as in claim 19, wherein said consumable is selected from the group consisting of baked goods, beverages, chocolate, ice cream, fragrances, popcorn, microwavable prepared foods.
